(19) United States
(12) Patent Application Publication
(10) Pub. No.: US 2014/0199218 A1
(43) Pub. Date: Jul. 17, 2014

(54) METHOD AND APPARATUS FOR ZERO EMISSION COMBINED HEAT AND POWER

(71) Applicants: Samuel M. Sami, Carlsbad, CA (US); Philip D. Baldwin, Tustin, CA (US); Herbert S. Hughes, Glendora, CA (US)

(72) Inventors: Samuel M. Sami, Carlsbad, CA (US); Philip D. Baldwin, Tustin, CA (US); Herbert S. Hughes, Glendora, CA (US)

(21) Appl. No.: 13/778,522

(22) Filed: Feb. 27, 2013

Related U.S. Application Data
(60) Provisional application No. 61/751,299, filed on Jan. 11, 2013.

(51) Int. Cl. B01D 53/92

(52) U.S. Cl. CPC B01D 53/92
USPC 423/212; 422/169; 422/119; 422/105

(57) ABSTRACT

An emissions control system and method of controlling emissions reduces contaminants in exhaust gases. The emissions control system may be a combined power and heat system which may include an organic Rankine cycle drive for producing electricity. The system may use ozone, a wet scrubber and a charcoal bed to reduce the contaminants.

### CROSS REFERENCE TO RELATED APPLICATION

This application claims priority from U.S. Provisional Application Ser. No. 61/751.299 filed Jan. 11, 2013; the disclosure of which is incorporated herein by reference.

### BACKGROUND OF THE INVENTION

1. Technical Field

The present invention relates generally to the mitigation or reduction of pollutants or contaminants in exhaust gases. More particularly, the invention relates to exhaust gases which are typically produced by internal combustion engines and which may be used in a combined heat and power system.

2. Background Information

Various types of systems have been proposed for the mitigation or elimination of pollutants or contaminants from exhaust gases, and in particular such contaminants as sulfur oxides (SOx), nitrogen oxides (NOx), volatile organic compounds (VOCs), carbon dioxide (CO₂) and heavy particulate matter (HPM). Currently, selective catalytic reduction (SCR) technology is successfully used in mitigating or eliminating these various contaminants from exhaust gases to meet current emissions standards. However, SCR technology is expensive to install, requires expensive high level maintenance and will be less likely to meet more stringent emissions standards of the future. SCR technology uses a catalyst to convert NOx into nitrogen gas (N₂) and water. Typically a gaseous reductant such as urea, anhydrous ammonia or aqueous ammonia is added to a stream of flue or exhaust gas and is absorbed onto the catalyst. When urea is used, CO₂ is a reaction product. In light of the limitations of the SCR technology and other systems, there is a need in the art for an improved and less costly system and method of mitigating contaminants from exhaust gases.

### BRIEF SUMMARY OF THE INVENTION

In one aspect, the invention may include an apparatus for reducing contaminants in exhaust gases, the apparatus comprising a duct positioned to receive the exhaust gases; an ozone generator having a discharge outlet in fluid communication with the duct; a wet scrubber which serves as part of the duct downstream of the discharge outlet of the ozone generator; and an activated carbon bed which serves as part of the duct downstream of the moisture scrubber.

In another aspect, the invention may include a method comprising the steps of directing a gas stream comprising exhaust gases through a duct; injecting ozone into the gas stream; passing the gas stream through a wet scrubber; and moving the gas stream from the scrubber through an activated carbon bed.

In another aspect, the invention may include an apparatus for reducing contaminants in exhaust gases, the apparatus comprising a duct adapted to receive the exhaust gases; a wet scrubber which serves as part of the duct and is adapted to use a liquor to strip contaminants from the exhaust gases to produce a contaminated liquid; a liquid reservoir adapted to contain the contaminated liquid; an ozone generator; and a sparge tube which is within the reservoir, is in fluid communication with the ozone generator and is formed with a plurality of exit openings adapted to allow for bubbling a gas comprising ozone into the contaminated liquid.

### BRIEF DESCRIPTION OF THE SEVERAL VIEWS OF THE DRAWINGS

One or more embodiments illustrative of the best mode in which Applicant contemplates applying the principles are set forth in the following description, are shown in the drawings, and are particularly and distinctly pointed out and set forth in the appended claims.

FIG. 1 is a diagrammatic view illustrating a sample system and method of the invention.

Similar numbers refer to similar parts throughout the drawings.

### DETAILED DESCRIPTION OF THE INVENTION

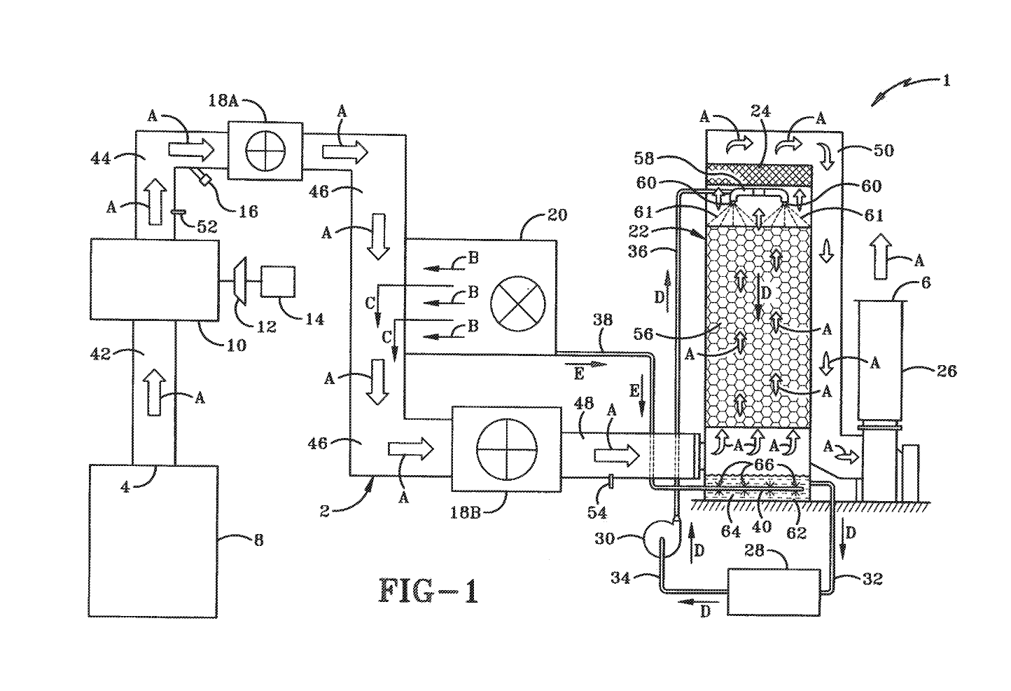

An illustrative embodiment of the emissions control system is shown generally at 1 in FIG. 1. In the exemplary embodiment, system 1 may also be understood to be a combined heat and power (CHP) system. System 1 includes a gas flow duct 2 having an upstream or entry end 4 and a downstream or exit end 6 such that a gas stream including exhaust gases moves or flows downstream through duct 2 from upstream end 4 to downstream end 6 and into the ambient or external atmosphere. Various components of system 1 typically form part of duct 2 as will be understood from additional description. System 1 includes or is connected to an exhaust gas generator 8 which may be essentially anything that produces exhaust gases and most typically is in the form of an internal combustion engine such as a reciprocating engine or a combustion turbine. System 1 also typically includes an organic Rankine cycle (ORC) drive 10 operatively connected to a turbine 12 and an electric generator 14 and configured to drive rotation of turbine 12 and generator 14 in turn to produce electric power. Examples of ORC drives are described in U.S. Pat. No. 8,276,383 granted to Sarni, which is incorporated herein by reference. Other ORC drives are well known in the art and may be used in system 1. System 1 further includes an air intake 16 which may be an ambient air intake, blowers 18A and 18B which typically are in the form of variable frequency drive (VFD) blowers, an ozone generator 20, a wet scrubber 22, a moisture eliminator 24, an activated carbon bed 26, a liquid filtration system 28, a liquid pump 30, a recirculation conduit or line including conduits or lines 32, 34 and 36, a sparge feed line 38 and a sparge tube 40.

As FIG. 1 illustrates, duct 2 includes various duct sections 42, 44, 46, 48 and 50 which extend between various of the components previously mentioned which are also part of duct 2 or serve as additional duct sections of duct 2. More particularly, duct section 42 at an upstream end thereof is connected to the exhaust port of exhaust gas generator 8, while the downstream end of duct section 42 is connected to an upstream end or inlet of ORC drive 10. Similarly, duct section 44 is connected at an upstream end thereof to the downstream end or exhaust port of ORC drive 10, and the downstream end of duct section 44 is connected to an upstream or inlet end of blower 18A. Duct section 46 at its upstream end is connected to the downstream or outlet end of blower 18 while the downstream end of duct section 46 is connected to the upstream end of blower 18B. Similarly, duct section 48 at its upstream and downstream ends is respectively connected to the downstream or outlet end of blower 18B and the upstream or inlet end of wet scrubber 22. Duct section 50 at its upstream end is connected to the downstream end of moisture eliminator 24, while duct section 50 at its downstream end is connected to the upstream end of carbon bed 26. Thus, each of ORC drive 10, blowers 18A and 18B, scrubber 22, moisture eliminator 24 and carbon bed 26 have a housing or duct work that serves as a duct section of duct 2. All these various duct sections are thus in fluid communication with one another to allow any gas flow or gas stream including exhaust gases to flow from generator 8 along the entire length of duct 2 and exit into the external atmosphere at downstream end 6 of duct 2. System 1 may also include temperature probes or sensors, such as indicated at 52 and 54 which extend into duct 2 or are otherwise able to measure the temperature of the gas flow within duct 2 at certain locations. Although temperature sensors may be placed in different locations, sensor 52 is shown mounted upstream of intake 16 while sensor 54 is shown mounted downstream of intake 16 and generally adjacent the upstream or intake end of water scrubber 22.

Cooling air intake 16 is located downstream of generator 8 and ORG drive 10, and upstream of wet scrubber 22, In the exemplary embodiment, intake 16 is also upstream of blowers 18A and B and ozone generator 20. Intake 16 typically includes a controllable valve which can be closed to cut off ambient or other cooling airflow into duct 2 or opened to any suitable degree to allow the intake of ambient or other cooling air into duct 2 at any chosen rate. Intake 16 may also include its own fan or blower to facilitate controlling the rate of cooling air that is injected into the air stream or gas stream as it moves through duct 2. More particularly, intake 16 is controlled to allow ambient or other cooling air into the gas stream within duct 2 to cool or lower the temperature of the gas stream and in particular cool the temperature of the gas stream sufficiently before entering scrubber 22 to avoid the gas stream from producing steam within wet scrubber 22, which would otherwise occur if the gas stream entering scrubber 22 were too hot.

Thus, temperature sensors 52 and/or 54 are typically in electrical or other communication with intake 16 in order to control the rate of flow of ambient air into duct 2 and thereby control the temperature of the gas flow, especially to avoid producing the above-noted steam. Whether the cooling air is ambient air or not, the cooling air immediately prior to entering the gas stream in duct 2 via intake 16 is cooler than (or has a lower temperature than that of) the gas stream in duct 2 immediately upstream of intake 16.

As previously noted, blowers 18A and 18B are typically VFD blowers. However, blowers 18 may be constant rate blowers configured to accommodate the proper flow rate of the gas stream though duct 2. In addition, one of blowers 18 may be a constant rate blower while the other one is a VFD blower, or each of blowers 18 may include a constant rate blower along with a VFD blower. In any case, blowers 18 are generally configured and/or controlled to essentially match the flow rate of the exhaust gases being exhausted from generator 8 or more generally to minimize back pressure to the exhaust gas flow from generator 8. Thus, blowers 18 are typically configured as pressure equalizing blowers.

Ozone generator 20 is shown mounted on or adjacent duct 2 and is in fluid communication therewith in the area adjacent Arrows B and C. More particularly, generator 20 is in fluid communication at a location downstream of generator 8 and ORC drive 10, and upstream of scrubber 22. In the exemplary embodiment, generator 20 is in fluid communication with duct 2 downstream of the upstream blower 18A and upstream of the downstream blower 18B. Generator 20 may include a blower for blowing or injecting the ozone into the gas stream moving through duct 2. Generator 20 is configured to generate a suitable amount of ozone to be delivered or injected into the gas stream in duct 2, More particularly, generator 20 is configured to be controlled to deliver ozone at a desired rate depending on an analysis of the exhaust gas being exhausted from exhaust gas generator 8. Thus, system 1 may include an exhaust gas analyzer for performing an exhaust gas analysis of the exhaust gas, and an ozone generator control for controlling the ozone delivery rate based on the exhaust gas analysis. The exhaust gas analyzer may be mounted on or positionable adjacent duct 2 to communicate with the gas stream including the exhaust gases within duct 2 upstream of generator 20 (such as along duct section 42 or 44). The ozone generator control may be located on generator 20 or elsewhere and is operatively connected to generator 20 and in electrical or other communication with the exhaust gas analyzer. The exhaust gas analyzer analyzes the exhaust gas upstream of ozone generator 20 and sends to the ozone generator control a signal indicative of an exhaust gas analysis of the exhaust gas performed by the analyzer. The ozone generator control thus controls generator 20 and in particular controls its ozone production rate and its ozone delivery rate into the gas stream in duct 2 based on the signal from the analyzer.

Wet scrubber 22 may be any of a variety of suitable wet scrubbers known in the art, such as a packed bed scrubber, a moving bed scrubber, a tray-type scrubber or any other wet scrubber which is suitable to the purposes of system 1. In the exemplary embodiment, scrubber 22 is a packed bed scrubber which is typically described as a tower. Scrubber 22 comprises a housing which defines an interior chamber in which is disposed packing 56 and suitable piping 58 which is above packing 56 and has outlets 60 typically in the form of spray nozzles. Scrubber 22 thus comprises a piping section which contains piping 58, a packing section which is below the piping section and contains packing 56, a gas stream intake section below the packing section, and a reservoir section which is below the gas stream intake section and includes reservoir 62. Nozzles 60 are configured to spray or otherwise eject a liquid 61, typically known as the liquor. Typically, wet scrubber liquor 61 is essentially all water or another aqueous solution which may contain other liquids or dissolved substances depending on the exhaust gases to be treated by system 1. In addition, scrubber 22 has a liquid reservoir 62 adjacent the bottom of scrubber 22 for collecting therein contaminated liquid 64.

System 1 has a recirculation loop which includes liquid filtration system 28, liquid pump 30, conduits or lines 32, 34 and 36, and wet scrubber 22. The recirculation loop thus includes the scrubber 22 piping section including piping 58, the scrubber 22 packing section, the scrubber 22 gas stream intake section and the scrubber 22 reservoir section including liquid reservoir 62. System 1 is configured to clean the contaminated liquid or liquor 64 and reuse it within scrubber 22. The recirculation path of the liquor along which the liquor is recirculated through the recirculation loop is thus broadly illustrated by Arrows D. Conduit or line 32 at an upstream end thereof is connected to an outlet of reservoir 62, and at a downstream end to an inlet of filtration system 28. Conduit or line 34 is connected at an upstream end to an outlet of filtration system 28 and at a downstream end to pump 30. Conduit or line 36 is connected at an upstream end to an outlet of pump 30 and at a downstream end to an inlet of piping 58.

Moisture eliminator 24 is downstream of scrubber packing 56 and outlets 60. Often, moisture eliminator 24 is within wet scrubber 22 itself and thus generally adjacent the top of the wet scrubber. A variety of moisture eliminators may be used which are suitable for the purposes of system 1. By way of example only, moisture eliminator 24 may be a chevron blade demister or a mesh pad demister. Activated carbon bed 26 is shown in the form of a carbon bed tower which contains a substantial amount of activated carbon. In the exemplary embodiment, the activated carbon is contained in multiple cells within the housing of the tower.

Sparge feed line 38 at an upstream end thereof is connected to ozone generator 20 or may be connected to another ozone generator. The downstream end of feed line 38 is connected to a sparge tube 40 within reservoir 62. Sparge tube 40 is thus in fluid communication with ozone generator 20 or another ozone generator. Sparge tube 40 is thus submerged within contaminated liquor 64 during operation of system 1. Tube 40 is formed with a plurality of holes or ports which serve as exit openings to allow for the bubbling of a gas, especially including ozone and/or air, into the contaminated liquid 64, said bubbles being indicated at 66.

Filtration system 28 may use any filtration devices suitable to the purpose of system 1. In the exemplary embodiment, system 28 typically includes ultraviolet light for the production of ozone along with suitable filter media, and a final sand filter system downstream of the filter media.

The operation of system 1 will now be described although it will be largely understood by the foregoing description. Generator 8 is operated to produce exhaust gases which are discharged from generator 8 and enter duct 2 at upstream end 4 as part of a gas stream which is cleaned and eventually is discharged from or exits at downstream end 6. As generator 8 is operating and producing exhaust gases, blowers 18 are operating, ozone generator 20 is operating to produce ozone, and pump 30 is operating to recirculate the liquor 61 for use in the scrubber 22. Although system 1 may be operated without the ORC drive 10, it obviously provides a distinct advantage in the ability to produce electric energy via electric generator 14. Thus, the exhaust gases from generator 8 provide the heat source for ORC drive 10. As will be understood by one skilled in the art, ORC drive 10 is configured to drive rotation of turbine 12, and in turn to drive operation of generator 14, which is operatively connected to turbine 12.

The gas stream including the exhaust gases then exits ORC drive and moves downstream therefrom. Temperature probe 52 measures the temperature of the exhaust gases at this point or at another stage typically upstream of intake 16. In response to or based on the temperature measured by sensors 52 and/or 54, intake 16 is controlled to provide the appropriate amount or rate of ambient air into the gas stream in duct 2 in order to cool the gas stream sufficiently to avoid production of steam in scrubber 22, as previously noted. To this effect, a cooling air intake control is provided which may be located at intake 16 or elsewhere, wherein the cooling air intake control is in electrical or other communication with the temperature sensor, operatively connected to intake 16, and configured to control the cooling air intake in the manner noted above in response to or based on the temperature which is measured by sensor 52 and/or 54, and typically communicated to the control via an electrical or other signal. Blowers 18 are controlled by a blower control to match the air flow from the exhaust of generator 8 and to force air into and upwardly through the water scrubber 22. Ozone generator 20 is also controlled to deliver or inject the appropriate amount of ozone into the air stream as determined by an exhaust gas analysis of the exhaust of generator 8. Arrows B indicate the generation of and movement of ozone from generator 20 toward duct 2 while Arrows C more particularly represent movement of ozone into the gas stream within duct 2. Thus, the injected ozone becomes part of the gas stream and is intended to eliminate the majority of the airborne VOCs, NOx, SOx and particulate matter within the exhaust gases.

The gas stream after injection of the ozone enters the gas stream intake section of water scrubber 22 above the reservoir 62 and liquid 64 therein and is forced upwardly through the packing 56, which is simultaneously being wetted by the liquor 61 exiting outlets 60 and moving downward by gravitational force. Thus, the gas stream is forced upwardly against the downward countercurrent flow of liquor 61 which is dispersed by packing 56, whereby liquor 61 strips or extracts various contaminants and especially the heavy particulate matter from the exhaust gas stream and carries it downwardly through the gas stream intake section into reservoir 62 as contaminated liquid or liquor 64. The gas stream then passes downstream beyond the packed bed 56 and enters and passes through moisture eliminator 24 to remove or eliminate moisture from the gas stream, and then passes through duct section 50 into carbon bed 26. The gas stream thus passes through the activated charcoal bed to capture any remaining airborne particulate matter which may have passed through scrubber 22 and moisture eliminator 24. The gas stream is thus discharged at exit end 6 from charcoal bed 26 into the atmosphere with a very low emission of contaminants, and preferably with essentially no emission of contaminants at all.

As previously noted, various contaminants including heavy particulate matter are stripped or extracted from the gas stream as it moves up through scrubber 22 by the downward flowing liquor 61. As also previously noted, the liquor collects in the reservoir 62 as contaminated liquor 64. During the operation of system 1, additional ozone is passed through sparge line 38 from ozone generator 20 or another ozone generator and into sparge tube 40 in order to allow the gas typically comprising ozone and air mixed therewith to bubble at 66 into the contaminated liquid 64. This bubbling or sparging process will help to keep the particulate matter suspended in liquor 64 until it dissolves. Any remaining particulate matter within liquor 64 will then be eliminated through the liquid filtering system 28. More particularly, the operation of circulating pump 30 causes liquid 64 to move through conduit 32 into filtration system 28, whereby the particulate matter is filtered out and the cleaned or filtered liquid or liquor 61 then travels from system 28 through conduit 34, through pump 30 and through conduit 36 back up to piping 58 where it is released from outlet 60 back onto packing 56 to repeat the process.

System 1 thus provides a system and method for substantially reducing and preferably entirely eliminating contaminants from exhaust gases produced by an exhaust gas generator such as generator 8. Furthermore, system 1 allows for the use of such generators as internal combustion engines to effect whatever work is desired, while also utilizing the hot exhaust gases as the heat source for ORC drive 10 to produce electricity via generator 14. System 1 thus provides in one embodiment a combined heat and power system which not only can be operated efficiently, but also may be operated with zero or nearly zero emissions of various contaminants, such as those specified herein.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An apparatus for reducing contaminants in exhaust gases, the apparatus comprising:
a duct adapted to receive the exhaust gases;
an ozone generator having a discharge outlet in fluid communication with the duct;
a wet scrubber which serves as part of the duct downstream of the discharge outlet of the ozone generator; and
an activated carbon bed which serves as part of the duct downstream of the wet scrubber.

2. The apparatus of claim 1 further comprising an exhaust gas analyzer upstream of the ozone generator; and an ozone generator control which is operatively connected to the ozone generator and in communication with the exhaust gas analyzer.

3. The apparatus of claim 1 further comprising a cooling air intake connected to the duct upstream of the wet scrubber.

4. The apparatus of claim 3 further comprising a temperature sensor along the duct adapted to measure a temperature of the exhaust gases in the duct; and a cooling air intake control which is in communication with the temperature sensor, which is operatively connected to the cooling air intake, and which is configured to control the cooling air intake based on the temperature measured by the temperature sensor.

5. The apparatus of claim 1 further comprising a blower operatively connected to the duct and adapted to blow a gas stream comprising the exhaust gases through the duct.

6. The apparatus of claim 5 wherein the blower is a variable frequency drive blower.

7. The apparatus of claim 1 further comprising a moisture eliminator in the duct downstream of the wet scrubber.

8. The apparatus of claim 1 further comprising a recirculation loop which is adapted to recirculate a wet scrubber liquor; wherein the recirculation loop comprises the wet scrubber, a liquid filtration system and a pump.

9. The apparatus of claim 8 wherein the recirculation loop comprises a wet scrubber packing section which contains packing.

10. The apparatus of claim 9 wherein the recirculation loop comprises a wet scrubber piping section having piping with at least one outlet above the packing section, and a wet scrubber liquid reservoir below the packing section.

11. The apparatus of claim 8 wherein the liquid filtration system comprises an ultraviolet light, filter media and a sand filter system.

12. The apparatus of claim 1 wherein the wet scrubber comprises a liquid reservoir adapted to collect therein contaminated liquid which is contaminated as a result of a wet scrubber liquor extracting contaminants from the exhaust gases passing through the wet scrubber; and further comprising a sparge tube which is within the reservoir and is formed with a plurality of exit openings adapted to allow for bubbling a gas into the contaminated liquid.

13. The apparatus of claim 12 wherein the sparge tube is in fluid communication with the ozone generator or another ozone generator.

14. The apparatus of claim 12 further comprising a recirculation loop which comprises the liquid reservoir and a liquid filtration system such that the recirculation loop is adapted to circulate the contaminated liquid from the liquid reservoir to the liquid filtration system to filter contaminants from the contaminated liquid to provide a filtered liquid which is circulated from the liquid filtration system through the wet scrubber back to the liquid reservoir.

15. The apparatus of claim 1 further comprising an organic Rankine cycle drive which serves as part of the duct and is adapted to use the exhaust gases as a heat source.

16. The apparatus of claim 15 further comprising a cooling air intake connected to the duct downstream of the organic Rankine cycle drive.

17. The apparatus of claim 15 further comprising an electric generator; wherein the organic Rankine cycle drive is operatively connected to the electric generator to drive operation of the electric generator.

18. The apparatus of claim 1 further comprising
a blower operatively connected to the duct and adapted to blow a gas stream comprising the exhaust gases through the duct;
an exhaust gas analyzer upstream of the ozone generator;
an ozone generator control which is operatively connected to the ozone generator and in communication with the exhaust gas analyzer;
a cooling air intake connected to the duct upstream of the wet scrubber;
a temperature sensor along the duct adapted to measure a temperature of the gas stream;
a cooling air intake control which is in communication with the temperature sensor, which is operatively connected to the cooling air intake, and which is configured to control the cooling air intake based on the temperature measured by the temperature sensor;
a moisture eliminator in the duct downstream of the wet scrubber;
a recirculation loop which is adapted to recirculate a wet scrubber liquor;
wherein the recirculation loop comprises a liquid filtration system, a pump and a liquid reservoir which is adapted to collect therein the liquor as a contaminated liquid; and
a sparge tube which is within the reservoir and is formed with a plurality of exit openings adapted to allow for bubbling a gas comprising ozone into the contaminated liquid.

19. A method comprising the steps of:
directing a gas stream comprising exhaust gases through a duct;
injecting ozone into the gas stream;
passing the gas stream through a wet scrubber; and
moving the gas stream from the scrubber through an activated carbon bed.

20. An apparatus for reducing contaminants in exhaust gases, the apparatus comprising:
a duct adapted to receive the exhaust gases;
a wet scrubber which serves as part of the duct and is adapted to use a liquor to strip contaminants from the exhaust gases to produce a contaminated liquid;
a liquid reservoir adapted to contain the contaminated liquid;
an ozone generator; and
a sparge tube which is within the reservoir, is in fluid communication with the ozone generator and is formed with a plurality of exit openings adapted to allow for bubbling a gas comprising ozone into the contaminated liquid.
